(19) United States
(12) Patent Application Publication
(10) Pub. No.: US 2016/0309732 A1
(43) Pub. Date: Oct. 27, 2016

(54) LEGUME-BASED DAIRY SUBSTITUTE AND CONSUMABLE FOOD PRODUCTS INCORPORATING SAME

(71) Applicant: General Mills, Inc., Minneapolis, MN (US)

(72) Inventors: Eric T. Gugger, Rogers, MN (US); Peter Galuska, Hudson, WI (US); Andrea Tremaine, Minneapolis, MN (US)

(21) Appl. No.: 15/136,556

(22) Filed: Apr. 22, 2016

Related U.S. Application Data
(60) Provisional application No. 62/152,305, filed on Apr. 24, 2015.
(60) Provisional application No. 62/248,930, filed on Oct. 30, 2015.

(51) Int. Cl. A23C 9/13; A23C 9/123

(52) U.S. Cl. CPC A23C 9/1315; A23L 1/2008; A23L 1/24; A23C 9/1236; A23V 2002/00

(57) ABSTRACT

A non-dairy substitute can be produced from comparatively high starch legumes, such as chickpeas and adzuki beans. In some examples, the non-dairy substitute is produced by hydrating the high starch legumes, remove excess water, and then heating the hydrated high starch legumes in the presence of water and amylase at a controlled pH to reduce the starch content of the legumes. The slurry of reduced starch content can then be filtered to remove insoluble fiber and suspended soluble fiber present in the legume slurry, producing a non-dairy “milk” that can be used in a variety of products. In different examples, the legume “milk” is cultured with the addition of bacterial cultures to form a cheese or yogurt and/or formed into a non-dairy ice cream. In any application, an acidifying ingredient such as citric acid may be added to the product. This can help reduce or eliminate residual legume flavor.

This application claims priority to U.S. Provisional Patent Application No. 62/152,305, filed Apr. 24, 2015 and U.S. Provisional Patent Application No. 62/248,930, filed Oct. 30, 2015. The entire contents of both these applications are incorporated herein by reference.

### TECHNICAL FIELD

This disclosure generally relates to techniques for liquefying legumes to produce legume “milk” as well as consumable food products incorporating the legume milk.

### BACKGROUND

Protein is an ingredient that continues to grow in consumer health interest and is an ingredient needed in the developing world. Traditional protein sources, such as meat, fish, and dairy products, provide high quality proteins but are costly, are often supply constrained, and for some consumers are undesirable food sources or are inconsumables due to lactose intolerance or other health concerns. For these reasons, consumers and food producers have sought alternative sources of protein that do not rely on animals for supply.

One alternative to animal-based proteins is protein extracted from edible plant crops. For example, soybeans have been used historically as a plant source of protein in products such as soymilk and tofu. Soybeans provide a good source of protein because they are easy to process and have a relatively neutral flavor profile. As consumers take an increasingly active interest in the source and content of their food, some consumers have turned away from soy-based products.

Alternative sources of non-animal-based (e.g., non-dairy) and non-soy-based products are limited. While other legumes besides soy can also have high amounts of protein, these legumes are more difficult to process than soy. For example, these legumes may form a viscous syrup or paste upon heating that is grainy in texture and of limited use in most products traditionally using animal protein. Further, non-soy legumes may have a distinct flavor that is difficult to neutralize and impacts the flavor of any food into which protein from the non-soy legume is incorporated.

### SUMMARY

In general, this disclosure is directed to techniques for producing liquefied legume materials, the liquefied legume material so produced, and consumable products incorporating such liquefied legume material. In some examples, the liquefied legume material is produced by hydrating a non-soy legume. While any non-soy legume can be used, in some examples, non-soy legumes such as chickpeas, adzuki beans, fava bean and/or red lentil are used as these legumes have been found to provide good texture, color, and/or flavor profile for the resulting liquefied legume material as well as good processing characteristics. This allows the liquefied legume material to be used as a non-dairy substitute in a variety of products typically using dairy ingredients without unduly influencing the flavor and texture of the resulting product.

Independent of the specific legume used, the legume may be hydrated, for example by rinsing the legume or soaking the legume in water to provide a hydrated legume. In instances where whole or hulled legumes are used, the legumes may also be milled to reduce the size of the legumes and increase the amount of legume surface area available for further reaction. If the legume is initially provided in milled form, such as a flour, the milling step may be skipped. In either case, the hydrated legume can be treated with amylase at elevated temperature to cause enzymatic digestion and liquefaction of starch in the hydrated legume. In one example, the hydrated legume is treated with an amount of amylase and mixed with the amylase at elevated temperature for a period of time sufficient to reduce the starch content in the slurry below 5 weight percent as measured on a dry weight basis, such as below 3 weight percent. In some applications, the resulting legume slurry having a reduced starch content is then filtered, for example, by passing the legume slurry through a porous membrane and/or centrifuging the legume slurry. This can remove larger particulates such as insoluble cellular material and/or fiber material (e.g., insoluble fiber and/or suspended soluble fiber), present in the legume slurry which could otherwise effect the taste and/or texture of a consumable product into which the legume slurry is incorporated.

The resulting legume slurry having the reduced starch content, whether or not filtered, can provide a legume “milk” that functions as a non-dairy substitute. This non-dairy substitute can be used in place of, or in addition to, dairy ingredients traditionally incorporated into consumable products. While the legume “milk” can be incorporated into a variety of products, in one example, the legume “milk” is cultured to produce a cultured non-dairy legume product. For example, the legume “milk” can be combined with starter culture containing bacteria selected to cause the legume “milk” to ferment. During fermentation, the legume “milk” can solidify and acidify, for example transforming into a legume-based cheese, a legume-based yogurt, or other legume-based cultured product. The fermentation process can work synergistically with the legume “milk” by imparting a richer and more dairy-like flavor profile to the resulting cultured product than the starting legume “milk.” This can help mask any residual legume flavors and textures present in the legume “milk,” providing a cultured non-dairy product that is similar to, or indistinguishable from, a comparable product produced using dairy milk.

As another example, the legume “milk” can be combined with a lipid (e.g., oil or other fat) to form a savory product, such a mayonnaise, dressing, or dip. It has been found that legume “milk,” in some examples, provides excellent emulsification properties without using a separate emulsification agent. Accordingly, an aqueous legume “milk” can be combined with a hydrophobic lipid, such as oil, to create an oil-water emulsion that is stable and that can contain flavoring agents. Because the legume “milk” can form a stable emulsion with oil, the legume “milk” can be used to prepare a variety of consumable products which require the mixing and integration of substances that are immiscible. Examples of such products include dressings (e.g., oil-based salad dressings), mayonnaise, and hollandaise sauces. In some applications, the legume “milk” is blended with oil and flavoring agents to form the products without using egg (e.g., such that the product is devoid of egg), creating a stable emulsion without the use of egg as an emulsification agent. This can be useful to create eggless analogue products for individuals that have egg allergies or dietary restrictions.

In one example, a method of producing a cultured non-dairy product is described. The method involves hydrating a non-soy legume having greater than 20 weight percent starch on a dry weight basis with water to produce a hydrated legume material by at least one of rinsing the legume with water and soaking the legume in water. The method further includes separating the hydrated legume material from excess water used to at least one of rinse the legume and soak the legume and combining the hydrated legume material with water and amylase to produce a legume slurry. The method further includes heating the legume slurry to a temperature greater than 150 degrees Fahrenheit but below boiling for a period of time sufficient to reduce a starch content of the legume slurry below 5 weight percent on a dry weight basis and thereby provide a legume slurry of reduced starch content and then filtering the legume slurry of reduced starch content to remove at least a portion of any insoluble fiber and suspended soluble fiber present in the legume slurry of reduced starch content. The method additionally includes adjusting a temperature of the legume slurry of reduced starch content to a range effective to activate a bacterial culture when added to the legume slurry of reduced starch content and adding the bacterial culture to the legume slurry of reduced starch content. Additionally, the method involves holding the legume slurry of reduced starch content with bacterial culture at the adjusted temperature for a period sufficient to acidify the legume slurry of reduced starch content to a pH of 4.7 or below, thereby producing a cultured non-dairy product.

In another example, a cultured non-dairy product is described that includes a cultured non-soy legume composition having a starch content ranging from 0.5 weight percent to 3 weight percent starch, a pH less than 4.7, and a viscosity ranging from 2,000 centipoise to 60,000 centipoise when measured at a temperature of 5 degrees Celsius. The cultured non-soy legume composition is substantially devoid of insoluble fiber (e.g., has an insoluble fiber content less than 5 weight percent on a dry weight basis) and substantially devoid of (or entirely devoid of) suspended particles having a size greater than 0.5 mm and is also devoid or substantially devoid of dairy products.

In another example, an eggless emulsion product is described that includes an aqueous non-soy legume composition forming an emulsion with oil and that is devoid of egg.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a flow diagram illustrating an example process for forming a liquefied legume material.

FIG. 2 is a flow diagram illustrating an example process for converting a liquefied legume material according to the example process of FIG. 1 into a cultured consumable product.

FIG. 3 is an image of a sodium dodecyl sulfate polyacrylamide gel electrophoresis showing example protein separation for different example chickpea milks.

### DETAILED DESCRIPTION

In general, this disclosure relates to techniques for producing liquefied legume material and products incorporating such liquefied legume material. In some examples, the liquefied legume material is produced by forming an aqueous slurry containing ground legumes and treating the slurry with a liquefaction enzyme. For example, the slurry may be treated with alpha-amylase and the conditions of treatment controlled to enzymatically breakdown starches present in the ground legumes. Depending on the application, the slurry may be filtered after enzymatic treatment to remove large particles, such as water insoluble fiber particles, suspended water soluble fiber particles, and other particles that can impact the texture of the product. The resulting legume slurry can then be cooled and used as a dairy (e.g., milk) substitute for products typically produced using dairy ingredients.

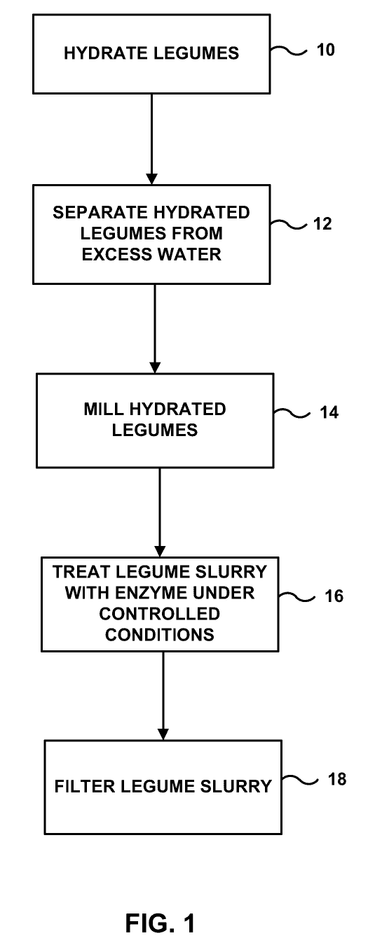

FIG. 1 is a flow diagram illustrating an example process for producing a liquefied legume material. The process includes hydrating legumes to produce a hydrated legume material (10) and optionally separating the hydrated legume material from excess water used to hydrate the legumes (12). If the legumes are milled before hydrating the legumes, the legumes can form a slurry upon addition of water that is subsequently treated with an enzyme under controlled conditions (16). Alternatively, if legumes are not milled before hydration, the legumes can be milled to reduce the size of the legumes and increase the surface area available for subsequent treatment (14). In either case, in the example technique of FIG. 1, the hydrated legumes are treated with a liquefaction enzyme under controlled processing condition (16). The liquefaction enzyme can breakdown starch in the slurry and reduce the viscosity of the slurry, reducing the starch content of the slurry. After enzymatic treatment, the technique of FIG. 1 includes filtering the slurry having the reduced starch content to provide a legume-based dairy substitute (18).

To make a liquefied legume material that can form an end product itself or that can be used as a dairy substitute, one or more select legumes are combined with water to hydrate the legumes (10). A variety of different legumes can be used to manufacture the liquefied legume material. In general, a legume is a plant from the family Leguminosae, which has a descent fruit such as a bean, pea, or lentil. Legumes typically have a pod or hull that opens along two sutures when the seeds of the legume are ripe. The term legume may refer to just the seed of the plant or the entire plant, depending on context and application.

In some examples, the liquefied legume material is produced using a pulse, which may also be referred to as a grain legume. The Food and Agricultural Organization of the United Nations recognizes eleven primary pulses:

1. Dry beans (Phaseolus) such as kidney bean, navy bean, pinto bean, haricot bean (Phaseolus vulgaris); lima bean, butter bean (Phaseolus lunatus); azuki bean (Vigna angularis); mung bean, golden gram, green gram (Vigna radiata); black gram, urad (Vigna mungo); scarlet runner bean (Phaseolus coccineus); ricebean (Vigna umbellata); moth bean (Vigna aconitifolia); and tepary bean (Phaseolus acutifolius),
2. Dry broad beans (Vicia faba) such as horse bean (Vicia faba equina); broad bean (Vicia faba); and field bean (Vicia faba),
3. Dry peas (Pisum) such as garden pea (Pisum sativum), protein pea (Pisum sativum),
4. Chickpea, garbanzo, Bengal gram (Cicer arietinum),
5. Dry cowpea, black-eyed pea, blackeye bean (Vigna unguiculata),
6. Pigeon pea, Arhar/Toor, cajan pea, Congo bean, gandules (Cajanus cajan),
7. Lentil (Lens culinaris),
8. Bambara groundnut, earth pea (Vigna subterranea),
9. Vetch, common vetch (Vicia sativa),

### 10. Lupins (Lupinus), and

11. Minor pulses such as lablab, hyacinth bean (Lablab purpureus); jack bean (Canavalia ensiformis); sword bean (Canavalia gladiata); winged bean (Psophocarpus tetragonolobus); Velvet bean, cowitch (Mucuna pruriens); and yam bean (Pachyrhizus erosus).

The legumes selected to produce the liquefied legume material may have a comparatively high starch loading, necessitating further processing according to the example technique of FIG. 1. In general, starch is a polymer formed of linked anhydro-a-D-glucose units. It may have either a mainly linear structure (amylose) or a branched structure (amylopectin). The molecular weight of the constituent polymers, particularly amylose, varies between different starch sources. In native, uncooked and ungelatinized form, the starch molecules amylose and amylopectin are located within starch granules that are insoluble in cold water. In different examples, the legumes used to produce the liquefied legume material may have greater than 10 weight percent starch as measured on a dry weight basis (e.g., excluding the weight of water added to hydrate and process the legumes), such as greater than 20 weight percent, greater than 30 weight percent, or greater than 50 weight percent starch. For example, the legumes may have a starch content ranging from approximately 30 weight percent to approximately 50 weight percent. These legumes may also contain comparatively high levels of protein (e.g., greater than 15 weight percent protein, such as greater than 20 weight percent protein) and some amount of oil.

While oilseed legumes such as soybeans and/or peanuts may be used in some applications of the technique of FIG. 1, in general, the legumes used in the process are selected to have a low oil content. High oil content can impart undesired fat calories to the resultant liquefied legume material and also limit the applicability of the liquefied legume material to function as a substitute for dairy ingredients during manufacture of a consumable product. Accordingly, in some applications, the legumes used to produce the liquefied legume material are non-oleaginous legumes (e.g., excluding oleaginous legumes), such as non-soy legumes (e.g., excluding soybeans). Depending on the characteristics of the specific legumes selected for processing, the non-oleaginous legumes may have an oil (e.g., lipid) content of less than 10 weight percent, such as less than 5 weight percent, less than 3 weight percent, or less than 1 weight percent. Such legumes can have starch loadings falling within any of the aforementioned values.

As specific examples, the non-oleaginous legumes chickpea and/or Adzuki bean and/or fava bean and/or red lentil can be used to produce the liquefied legume material. These legumes have been found to provide good texture, color, and/or flavor profile for the resulting liquefied legume material and also provide good processing characteristics.

In one application, a single type or class of legume (e.g., chickpeas) is used to produce the liquefied legume material. For example, the liquefied legume material may be formed using greater than 90 weight percent of a single type or class of legume, such as greater than 95 weight percent, greater than 98 weight percent, or 100 weight percent. This can be beneficial so that the liquefied legume material only carries the residual flavor of a single type or class of legume. If only a single legume flavor profile is present in the liquefied legume material, it can be easier to mask the flavor with other additives in a resultant product. In other applications though, multiple types or classes of legumes are used to produce the liquefied legume materials. This can be beneficial to introduce different types of proteins and nutrients into the liquefied legume material.

Independent of the specific type or types of legumes selected to produce the liquefied legume material, the legumes are hydrated (10) in the technique of FIG. 1 to produce a hydrated legume material. In different examples, the legumes are rinsed with water or soaked in a vessel of water to hydrate the legumes. Hydrating the legumes increases the amount of water absorbed by the legumes, swelling the legume structure and preparing the legume for chemical and mechanical breakdown. Further, hydrating the legumes can cause water soluble components to leach out of the legumes, allowing the water soluble components to be extracted from the legumes rather than incorporated into the resulting liquefied legume material. For example, hydrating the legumes can help remove water soluble non-digestible sugars such as raffinoses present in the legumes, which can contribute to intestinal gas production, as well as flavonoids and other phytochemicals which can contribute to bitter taste and off color.

The duration of hydration and conditions of the water used to hydrate the legumes can vary, e.g., depending on the type and quality of the legumes used. In instances where the legumes are soaked in water, the legumes may be soaked using cool water and/or under chilled conditions to help prevent spore germination and lipid breakdown in the legumes. For example, the legumes may be soaked in water at a temperature less than 50 degrees Fahrenheit (e.g., less than 40 degrees Fahrenheit), which may be accomplished by adding cool water to a vessel containing the legumes and refrigerating the vessel. While the duration of soaking can vary, in some examples, the legumes are soaked for a period of at least one hour, such as at least 4 hours, at least 6 hours, at least 8 hours, or at least 24 hours. In instances where the legumes are rinsed with water, cool rinsing water (e.g., less than 50 degrees Fahrenheit) may be used or, since the water is in contact with the legumes for a shorter period of time than when soaking, warmer temperature water may be used as desired.

The amount of water used to hydrate the legumes can range from a volume ratio of legumes to water from 1:0.1 (i.e., 1 volume part legume per 0.1 volume part water) to 1:20, such as 1:0.5 to 1:5. In instances where the legumes are soaked, the volume ratio of legumes to water may be at least 1:1 (e.g., at least 1:2) to ensure sufficient extraction of water-soluble components from the legumes. It should be appreciated that the foregoing volume ratios are merely examples and the disclosure is not limited in this respect.

The technique of FIG. 1 also includes optionally separating the hydrated legumes from excess water (12). As discussed above, water-soluble components can leach from the legumes during hydration and create off flavors if left in the resulting liquefied legume liquid. For this reason, excess water that is contacted with the legumes but not absorbed by the legumes may be separated from the hydrated legumes. This removes the leached out water-soluble components from the hydrated legumes for further processing. In different applications, the hydrated legumes can be separated from the excess water by allowing rinse water to flow over and pass through the legumes (e.g., through a colander or sieve) or by draining water from a vessel containing soaking water and the legumes (e.g., by passing the vessel contents through a colander or sieve). While the example technique of FIG. 1 includes separating the hydrated legumes from excess water used to hydrate the legumes (12), in other applications, the water can remain with the legumes during further processing and form part of the liquefied legume material. This can be appropriate in situations where off flavors from water-soluble legume components are not of particular concern, such as where the liquefied legume material is intended for animal feed applications.

After optionally separating the hydrated legumes from excess water (12), the technique of FIG. 1 further includes optionally milling the hydrated legumes (14) to produce hydrated legumes of reduced size. In general, the legumes are milled down to a size effective to allow enzymes to access the entire legume structure for hydrolyzing starch but not so small that legume particulate cannot be filtered during subsequent processing. In instances where legumes are milled before hydration—for example, by using a legume flour starting material—further milling after hydration is typically not required. However, where a whole or hulled legume is used that is not pre-milled, the legume may be milled after hydration to reduce the size of the hydrated legume particles subject to further treatment.

The hydrated legume material can be milled (14) by grinding or otherwise shearing the material. In some applications, the hydrated legume material is milled to an average particle size less than 1 millimeter, such as an average particle size less than 0.5 millimeters, or an average particle size less than 0.3 millimeters. For example, the hydrate legume material may be milled to an average particle size ranging from 1 micrometer to 300 micrometers, such as an average particle size ranging from 25 micrometers to 100 micrometers. Although any suitable milling process can be used, milling the hydrated legume material in a vacuum atmosphere and/or in a non-oxygen atmosphere (e.g., under a nitrogen blanket) can be useful to inhibit oxidation of the hydrated legume material. This can help minimize formation of off flavors in the resulting liquefied legume liquid.

The example technique of FIG. 1 further includes treating the hydrated legume material with an enzyme under controlled conditions to breakdown starch molecules present in the material (16). In applications where the hydrated legume material is first separated from excess water used to hydrate the legumes (and optionally milled thereafter), the hydrated legume material (e.g., of reduced size after milling) may be combined with additional water and a liquefaction enzyme to breakdown starch in the hydrated legume material. In these applications, the amount of water added to the hydrated legume material can vary, e.g., based on the desired viscosity of the resulting liquefied legume material. In some examples, the volume of water added to the legume material is effective to provide a volume ratio of legumes to water of at least 1:1 (e.g., from 1:1 to 1:3). In other applications where excess water used to hydrate the legumes is not separated from the hydrated legume material, additional water may or may not be added to the water used to hydrate the legumes for further processing.

The hydrated legume material combined with water can form a slurry for further processing. In the technique of FIG. 1, the legume slurry is treated with a liquefaction enzyme (16) by adding the liquefaction enzyme to the slurry or a constitute component thereof (e.g., the water that is then added to the hydrated legume material). The liquefaction enzyme may be selected as an enzyme that breaks down starch and/or other organic molecules in the slurry. As the starch and/or other organic molecules in the slurry breakdown, the viscosity of the slurry may decrease, providing a more flowable and liquid material.

Typically, an amylase enzyme or combination of amylase enzymes are used as the liquefaction enzyme to breakdown starch in the product. There are three stages in the usual enzymatic conversion of starch to glucose and maltose. First, the starch is gelatinized, involving the dissolution of starch granules to form a viscous suspension. Second, the gelatinized starch is liquefied, involving the partial hydrolysis of the starch, with concomitant loss in viscosity. Third, the liquefied starch is saccharificated, involving the production of glucose and maltose by further hydrolysis.

The amylase enzyme used to breakdown the starch in the product may be, for example, alpha-amlase, beta-amylase, and/or glucoamylase. Alpha-amylase (e.g., α-D-1,4-glucan glucanohydrolases) generally refers to a group of endohydrolases that cleave α-D-1,4-glucosidic bonds but do not substantially hydrolyze α-D-1,6-glucosidic branch points. This group of enzymes shares a number of common characteristics such as a (β/α)₈ barrel structure, the hydrolysis or formation of glucosidic bonds in the a configuration, and a number of conserved amino acid residues in the active site. Depending on the relative location of the bond under attack as counted from the end of the chain, the products of these processes may include dextrin, maltotriose, maltose, and glucose. Dextrins are shorter, broken starch segments that form as the result of the random hydrolysis of internal glucosidic bonds. A molecule of maltotriose is formed if the third bond from the end of a starch molecule is cleaved; a molecule of maltose is formed if the point of attack is the second bond; and a molecule of glucose results if the bond being cleaved is the terminal one.

Beta-amylase generally refers to enzymes that catalyze the liberation of maltose from the nonreducing ends of starch. The enzyme typically has a specificity to produce β-anomeric maltose. Glucoamylase (e.g., α-1,4-glucan glucohydrolase) generally refers to an exoglucosidase that catalyzes the hydrolysis of α-1,4 bonds releasing glucose units from the non-reducing end of a starch substrate. Glucoamylase can acts on α-D-1,6 bonds at the branch point, although this hydrolysis occurs at a slower rate.

Independent of the specific type of enzyme(s) used to liquefy the slurry containing the hydrated legume material of reduced size, the slurry containing the enzyme can be processed under conditions effective to reduce the starch content in the slurry. For example, the slurry containing the enzyme can be heated (e.g., while mixing) to a temperature effective to activate the enzyme and cause enzymatic digestion of starch molecules. To prevent precipitation and coagulation of proteins from the slurry, however, the temperature of the slurry may be kept below a temperature effective to cause precipitation of legume proteins from the slurry. For example, the temperature of the slurry may be kept below boiling temperature to help prevent precipitation of legume proteins from the slurry. Depending on the activation temperature of the enzyme selected for use in the slurry, the slurry may be heated to a temperature ranging from greater than 120 degrees Fahrenheit to below boiling (e.g., 212 at normal atmospheric pressure, such as a temperature greater than 150 degrees Fahrenheit but below boiling, or a temperature ranging from 160 degrees Fahrenheit to 185 degrees Fahrenheit.

The pH of the slurry may or may not be adjusted by adding an acid or base to the slurry, e.g., depending on the activation pH of the enzyme used and the pH of the water added to the hydrated legume material of reduced size. In some applications, the pH of the slurry is adjusted to a pH ranging from 6.5 to 8.5, such as from 6.8 to 7.3. Although some enzymes exhibit higher activity at a lower pH (e.g., around a pH of 6), keeping the pH of the slurry at a higher value (e.g., at or above 6.5) can help reduce or eliminate protein precipitation.

Any suitable acid or base can be used to adjust the pH of the slurry. As one example, the pH of the slurry may be increased by adding calcium hydroxide or calcium carbonate to the slurry. The anion portion of the molecule can function to increase the pH of the slurry while the cation portion of the molecule introduces calcium into the slurry. Calcium can help heat stabilize the enzyme during further processing. For this reason, in instances where a calcium-containing base is not added to the slurry to adjust the pH of the slurry, a calcium source may nevertheless be added to the slurry to increase the calcium concentration in the slurry. For example, an amount of calcium source effective to achieve a calcium concentration ranging from 50 ppm to 100 ppm may be added to the slurry.

Independent of the temperature and pH conditions selected for processing the slurry, the slurry can be treated with the enzyme for a period of time sufficient to reduce the starch content in the slurry below a desired value. For example, the slurry may be treated with the enzyme for a period of time sufficient to reduce the starch content in the slurry below 5 weight percent as measured on a dry weight basis (e.g., excluding water weight), such as below 3 weight percent, below 1 weight percent, or below 0.5 weight percent. In general, the starch content is the percentage of unmodified, natural starch present in the slurry and excludes broken starch segments formed during hydrolysis, such as dextrins.

As examples, the slurry can be treated with the enzyme for a period of time sufficient to reduce the starch content in the slurry to a range from 0.5 weight percent as measured on a dry weight basis to 3 weight percent. The actual amount of time need for processing will vary based on factors such as the amount of starch in the slurry before treatment, the amount of enzyme added to the slurry, and the activity of the slurry. For example, the actual amount of time may range from 20 minutes to 4 hours, such as from 30 minutes to 2 hours. If desired, residual enzymatic activity may be destroyed by lowering the pH towards the end of the processing period or raising the temperature to denature the enzymes. In either case, the product present at the end of the enzymatic processing (16) may be a legume-based slurry having reduced starch content (as compared to the starch content of the slurry before enzymatic treatment).

In some applications, the pH of the legume-based slurry having reduced starch content is increased after enzymatic digestion but prior to filtering. Increasing the pH of the legume-based slurry having reduced starch content may help prevent chemical components that impact the emulsification properties of the resulting legume milk from being filtered out of the legume-based slurry having reduced starch content during subsequent filtering. Without wishing to be bound by any particular theory, it is believed that one or more compounds released from the legumes into the legume-based slurry may function to emulsify oil-based ingredients added to the resulting aqueous legume milk. In some applications, this compound or compounds are believed to precipitate below a certain pH, potentially causing the component(s) to be filtered out during the production of the legume milk. By increasing the pH of the legume-based slurry having reduced starch content before filtering, the compound (s) may be solubilized and therefore pass through the filter during the filtration step. As a result, the compound (s) can impart emulsification properties to the resulting legume milk or product produced from the milk even if the pH of the milk or product is subsequently reduced below the precipitation limit for the protein(s).

In some examples, the pH of the legume-based slurry having reduced starch content having increased to a pH greater than 7.0 before filtering, such as a pH greater than 7.25, greater than 7.3, greater than 7.33, or greater than 7.44. For example, when a legume-based slurry having reduced starch content is formed using chickpeas, the legume slurry may be enzymatically digested at a pH ranging from 6.5 to 7.2 and the pH subsequently raised after enzymatic digestion but prior to filtering to a pH greater than 7.2 (e.g., from 7.3 to 8.5). In applications where the enzyme used to enzymatically digest the legume slurry functions at an elevated pH, the pH of the slurry may be raised above the precipitation limit of those protein(s) that provide emulsification functionality to the resulting milk prior to enzymatically digesting starch in the slurry. Any base (e.g., suitable for mammalian consumption) can be used to increase the pH of the legume-based slurry having reduced starch content.

In the technique of FIG. 1, the slurry having the reduced starch content is filtered (18) to produce the liquefied legume material. Filtering can remove comparatively large particles from the slurry that can otherwise affect the taste and/or texture of the slurry or a product produced using the slurry. For example, filtering may remove at least a portion (and, in some examples, substantially all or all) of any insoluble cellular material and/or fiber material (e.g., insoluble fiber and/or suspended soluble fiber) present in the slurry. Filtering can be accomplished by passing the slurry through a porous membrane and/or centrifuging the slurry. In some examples, filtering may remove particles greater than 1 millimeter (mm), such as particles greater than 0.5 mm, or greater than 0.1 mm from the slurry having the reduced starch content.

The resulting product following the process of FIG. 1 may be a liquefied legume material or legume “milk” that can be used as an end product itself (e.g., for direct consumption) or that can be incorporated into or used for a variety of other products. For example, the liquefied legume material may be evaporated to further reduce water content and made into a syrup, spray dried, precipitated, or gelled. As other examples, the liquefied legume material may be incorporated into a consumable product (e.g., as a dairy milk substitute). A wide variety of products may contain or use the liquefied legume material. Example products include consumable foods, beverages, and nutritional supplements. The consumable products may be suitable for mammalian consumption, such as by humans and animals (e.g., cats, dogs, horses, cows). Specific examples of products that may include or utilize the liquefied legume material include traditional dairy-type foods such as ice cream, yogurt, and sour cream; meat analogues; bar binders; food coatings; dressings, dips, and sauces; and the like.

While the liquefied legume material can be used in any desired consumable food products, in one application, the material is processed to form a cultured food product. The cultured food product may or may not utilized dairy ingredients in addition to the liquefied legume material. For example, the cultured food product may be devoid of dairy ingredients such that the resulting product is a non-dairy product in which the liquefied legume material functions as a milk substitute. A cultured food product may be a product that utilizes a microbial culture or its enzymatic equivalent for production of a distinguishable product from legume protein present in the liquefied legume material. Cultured food products include, but are not limited to, natural cheese, yogurt (e.g., Swiss-style, Greek-style), kefir, kumys, cream cheese processed cheese, dressings, dips (e.g., hummus), spreads, and sour cream. Because these and other cultured food products are often associated with being formed from dairy ingredients, cultured legume-based products produced in accordance with this disclosure may be analogues to traditional dairy products. For example, the cultured legume-based products can exhibit similar taste, texture, viscosity and/or other properties to a corresponding traditional dairy-based cultured product but be formed using non-dairy ingredients. Therefore, when terms such as “yogurt,” “sour cream,” and the like are used herein, it should be appreciated that the product may be an analogue to the traditional product and be formed (optionally) without dairy ingredients.

Any bacterial culture useful for fermenting the liquefied legume material into a desired cultured product can be used. Examples of live and active bacterial cultures that can be used to ferment the liquefied legume material include, but are not limited to, Lactobacillus bulgaricus, Streptococcus thermophilus, Lactobacillus bifidus, Lactobacillus lactis, Lactobacillus casei, Lactobacillus acidophilus, Bifidobacterium lactis, Bifodobacterium bifidus, Lactococcus cremoris, and/or Lactococcus lactis.

The cultured food product produced using the liquefied legume material can include optional sweeteners, flavor ingredient(s), process viscosity modifier(s), vitamin(s), and/or nutrient(s). Other ingredients that may be included are gel-forming additives, stabilizers, sequestrants, and the like.

For example, when sweeteners are used in the cultured food product, the sweetener may be a nutritive carbohydrate sweetening agent. Exemplary nutritive sweetening agents include, but are not limited to, sucrose, liquid sucrose, high fructose corn syrup, dextrose, liquid dextrose, various DE corn syrups, corn syrup solids, beet or cane sugar, invert sugar (in paste or syrup form), brown sugar, refiner's syrup, molasses, fructose, fructose syrup, maltose, maltose syrup, dried maltose syrup, malt extract, dried malt extract, malt syrup, dried malt syrup, honey, maple sugar, and mixtures thereof. In low fat and/or low calorie variations, high potency non-nutritive carbohydrate sweetening agents can be used, such as aspartame, sucralose, acesulfame potassium, saccharin, cyclamates, thaumatin, tagatose, rebaudioside, and/or stevia. When used, the sweetener may be present in an amount of from 0 to 20 weight percent, such as less than 15 weight percent based on the total weight of the cultured food product.

In some applications, a viscosity modifier is added to liquefied legume material to adjust the viscosity of the resultant product. Example viscosity modifiers include agar, alginate, carrageenan, pectin, starch, xanthan/locust bean gum, gellan gum, konjac gum, carboxy methyl cellulose (CMC), sodium alginate, hydroxy propyl, methyl cellulose, and combinations thereof. When used, the viscosity modifiers may be added to the liquefied legume material in an amount ranging from 0.1 to 5 weight percent, such as from 0.5 to 3 weight percent, based on the total weight of the cultured food product.

The cultured food product can be formulated so that the composition of the final refrigerated cultured product has a viscosity of greater than about 1,500 centipoise (cP) at 5° C. In one example, the final viscosity of the cultured composition of the refrigerated food product ranges from about 2,000 to about 60,000 cP at 5° C., such as from 15,000 to 30,000 cP at 5° C. The viscosity of the product may be lower if the consumable product is a beverage or other flowable product (e.g., have a viscosity less than 10,000 cP at 5° C.) or higher if the product is thick and substantially solidified (e.g., have a viscosity greater than 50,000 cP at 5° C.). In different examples, the cultured food product may be a whipped or gelled cultured composition. Further, where the cultured food product is a yogurt it may or may not be strained. Straining can be accomplished using mechanical separation means (e.g., a centrifugal separator or ultrafiltration) to concentrate the product before it is completely cooled after fermentation.

When straining, the straining can be performed under various temperature conditions to control the properties of the resultant strained product. For example, it has been observed that chilling the cultured legume-based product (e.g., to a temperature less than 50 degrees Fahrenheit, such as a temperature at or below 40 degrees Fahrenheit) can result in a smoother and creamer product. This can be useful when creamy products such as yogurt and ice cream are produced using the cultured legume-based product. In other applications, however, such as thick dips or sauces are desired to be produced from the cultured legume-based product, the product may be strained hot (e.g., at a temperature greater than 100 degrees Fahrenheit) after fermentation. This can result in a thicker and more textured product.

The cultured food product can further include a variety of adjuvant materials to modify the nutritional, organoleptic, flavor, color, or other properties of the composition. For example, the cultured food product can include synthetic and/or natural flavorings, and/or coloring agents. Any flavors typically included in cultured food products can be used. Also, flavor materials and particulates, such as fruit and fruit extracts, nuts, chips, partially puffed cereals, and the like, can be added to the cultured dairy compositions as desired.

When fruit and/or fruit extracts (e.g., sauces or purees) are used, any variety of conventional fruit flavorings can be used. Typical flavorings include strawberry, raspberry, blueberry, strawberry-banana, boysenberry, cherry-vanilla, peach, pineapple, lemon, orange and apple. In some applications, a fruit that has sulfur taste is used to help mask residual legume flavors, such as a tropical fruit (e.g., mango, papaya). Generally, fruit flavorings may include fruit preserves and fruit or fruit puree, with any of a combination of sweeteners, starch, stabilizer, natural and/or artificial flavors, colorings, and preservatives.

One particular ingredient that may be added to the cultured food product is an acidifying agent, such as citric acid. For example, juice from a citrus fruit (e.g., lemon, lime, orange, grapefruit) can be added to the cultured food product produced using the liquefied legume material. The acidifying agent may be added in an amount ranging from 0.1 to 5 weight percent based on the total weight of the cultured food product. It has been observed that addition of citric acid to a cultured food product produced using a liquefied legume material can help mask residual legume flavors and textures, providing a cultured non-dairy product that is similar to, or indistinguishable from, a comparable product produced using dairy milk.

Another example ingredient that may be added to the liquefied legume material is a probiotic. Probiotic bacteria and yeast can provide various benefits such as promoting gastrointestinal (GI) tract health, supporting immune functions, and increasing overall body defense mechanisms. When used, probiotic cultures from a single culture or a combination of two or more cultures can be combined with the liquefied legume material. Typical probiotics that may be used include Lactobacillus species, such as L. rhamnosus, L. acidophilus, L. crispatus, L. fermentum, L. plantarum, L. casei, L. paracasei, L. jensenii, L. gasseri, L. cellobiosis, L. brevis, L. delbrueckii, L. rogosae, and L. bifidum, and Bifidobacterim species, such as B. infantis, B. animalis, B. lactis, B. adolescentis, B. bifidum, B. pseudolongum, and B. longum. In some examples, probiotic organisms may be added to achieve a count in the final product greater than 10 million/g, such as greater than 50 million/g, or greater than 100 million/g.

Introducing probiotic bacteria into a liquefied legume material undergoing culturing may provide a synergistic combination that enhances the acid production and reduction in pH during culturing. Probiotic bacteria typically do not multiply or produce acid readily in dairy-based cultured products, such as yogurt. However, it has been observed that when probiotic bacteria are added to a non-dairy, legume-based product (e.g., before, during, or after culturing) in some applications, the probiotic bacteria are metabolically active. Moreover, acid produced by the probiotic bacteria can help reduce the pH of the legume-based product undergoing culturing, enhancing the resulting product.

In addition to or in lieu of the ingredients discussed above, a lipid or lipid-containing component (e.g., fat, oil) may be blended into the cultured food product to enhance the creaminess of the product. Because legumes are generally low in fat, a cultured food product produced from liquefied legume material may lack the creamy taste and texture associated with traditional dairy products. Blending lipids into the cultured food product can help impart the creamy taste and textures desired by many consumers.

A variety of different lipid-containing ingredients can be used, for example, depending on the type of cultured food product being produced and the desired flavor characteristics of the product. Example lipid-containing ingredients that can be used include oil (e.g., vegetable oil, sunflower oil, peanut oil, olive oil, safflower oil, soybean oil, rapeseed oil, corn or maize oil, cottonseed oil), dairy ingredients (e.g., milk, cream), and non-dairy substitutes, such as cream or milk derived from fruit or nuts. When used, the lipid-containing ingredient(s) may be added to the liquefied legume material (before fermentation) or resulting cultured food product (after fermentation) in an amount ranging from 0.1 to 8 weight percent, such as from 2 to 5 weight percent, based on the total weight of the material/product.

As one example, a cream or milk derived from a fruit (e.g., a drupe) or tree nut may be blended into the liquefied legume material (before fermentation) or resulting cultured food product (after fermentation). An example fruit cream that can be used is coconut cream, which can be made by simmering shredded coconut with water or milk until frothy, straining the resulting mixture, cooling, and separating the non-liquid cream from the remaining coconut milk. An example tree nut cream that can be used is almond cream. The cream and/or milk may or may not be sweetened. In some examples, a milk and/or cream derived from a fruit or tree nut is blended with the liquefied legume material before fermentation and then fermented with the liquefied legume material. In other examples, the milk and/or cream derived from a fruit or tree nut is blended with the liquefied legume material after fermentation.

Blending a cream or milk derived from a fruit or tree nut with the liquefied legume material or a resulting cultured food product can be useful to impart desirable flavor notes to the product while also imparting creaminess. In addition, because liquefied legume material and products derived therefrom in accordance with examples of the disclosure have been found to form stable emulsions, lipid-containing ingredients can be blended legume-based dairy analogues to produce products that maintain stable emulsions over the shelf lives of the products.

In some applications were a lipid-containing ingredient is added to cultured food product being produced, the lipid-containing ingredient may be added

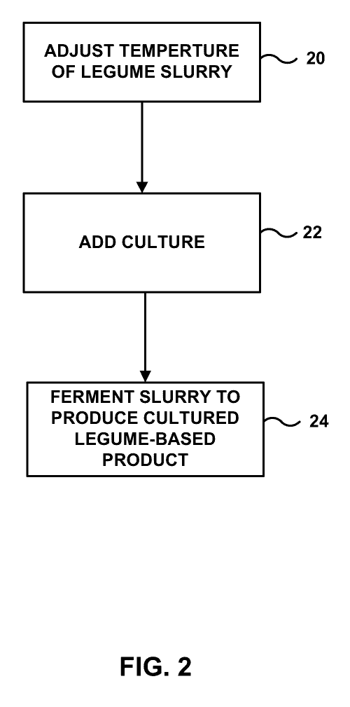

FIG. 2 is a flow diagram illustrating an example process for converting a liquefied legume material according to the example process of FIG. 1 into a cultured consumable product. As shown, the example process includes adjusting the temperature of the liquefied legume material to a temperature effective to activate bacterial cultures upon their addition and cause fermentation of the product (20). If the temperature of the liquefied legume material is too hot or too cold, it can kill or deactivate the bacterial cultures. Accordingly, the temperature of the liquefied legume material can be adjusted to a range effective to activate the bacterial cultures.

The specific temperature may vary based on the type of bacterial cultures used. In some examples, the temperature of the liquefied legume material is adjusted to a temperature ranging from 100 degrees Fahrenheit to 120 degrees Fahrenheit. If the liquefied legume material is at a higher temperature from the enzymatic starch digestion process, the temperature of the liquefied legume material can be reduced. Conversely, if the temperature of the liquefied legume material is below the targeted temperature range, the temperature of the material can be increased.

The process of FIG. 2 further includes adding a desired bacterial culture to the liquefied legume material (22). As discussed above, the specific cultures used can vary depending on the type of cultured produce desired to be produced. In the case of a cultured yogurt, the bacterial cultures Lactobacillus bulgaricus and Streptococcus thermophilus may be added to the liquefied legume material.

After adding the bacterial culture to the liquefied legume material (22), the process of FIG. 2 further includes holding the liquefied legume material with bacterial culture at the adjusted temperature for a period of time sufficient to reduce the pH of the product below a desired threshold, such as a pH of 4.7 (24). During this time, proteins in the liquefied legume material can ferment and the product can acidify. In some examples, the liquefied legume material is fermented until the pH of the product is equal to or less than 4.6, such as a pH ranging from 4.2 to 4.6. Depending upon temperature and the amount of culture added, the fermentation process may take from about three to about 14 hours, such as from about 4 to about 8 hours, to reach the desired pH. When the proper pH has been reached, the resulting fermented product can be cooled (e.g., to about 2 to 21° C.) to arrest further growth and any further drop in the pH. The various option ingredients and additives discussed above can be added to the liquefied legume milk before fermentation or, more typically, after fermentation.

The resulting cultured legume-based product (e.g., yogurt) can be packaged for direct consumption or further processed, for example by transforming it into a frozen yogurt. The cultured product can be frozen, e.g., by reducing the temperature of the produce below freezing and by using a continuous freezer barrel system comprising a dasher and scraper blades, such as is conventionally used to prepare ice cream. The frozen cultured product can be shaped to form portions by an extrusion and cutting process, optionally onto a conveyor belt for delivery to a coating station.

As mentioned above, a liquefied legume material according to the disclosure can be used to produce a wide variety of products, including both fermented and non-fermented products. As another example class of products, the liquefied legume material may be blended with a lipid-containing ingredient (e.g., fat, oil) to produce an emulsion product. An oil/water emulsion product may be characterized by having oil droplets dispersed evenly throughout an aqueous phase. In traditional products, these oil droplets will tend to coalesce over time and an emulsifying agent is needed to prevent coalescence. For example, egg is often used as a natural emulsifying agent to form emulsified oil/water blends and prevent separation of the constituent ingredients.

In accordance with the present disclosure, it has been found that a liquefied legume material can function as an emulsification agent, allowing fat, oil, or other lipids to be blended into the aqueous liquefied legume material without requiring a separate emulsification agent. For example, the liquefied legume material may form a stable emulsion at a variety of lipid loadings and a variety of temperature ranges. Oil/fat may be blended with the liquefied legume material to provide a product that has, e.g., from 5 wt % to 85 wt % oil/fat, such as from 15 wt % to 75 wt %, or from 25 wt % to 70 wt %. The resulting product may form a stable emulsion without the addition of a separate emulsification agent over a range of temperature, such as from 10 degrees Celsius to 80 degrees Celsius, or from 20 degrees Celsius to 50 degrees Celsius. The emulsification may be stable in that at least 90 wt % of the fat/oil added to the liquefied legume material may remain in emulsion with the aqueous phase over the shelf life of the product (e.g., at least 6 months), such as at least 95 wt % or at least 99 wt % of the fat/oil added to the material. Accordingly, the liquefied legume material may be used to produce a variety of traditional emulsion product but without using an emulsification agent (e.g., egg).

In one example, the liquefied legume material may be used to form a mayonnaise. The liquefied legume material can be blended with fat/oil in an amount effective to provide from 25 wt % to 85 wt % fat/oil in the resulting product, such as 50 wt % to 85 wt %, or 60 wt % to 80 wt %. In some examples, the mayonnaise is formed by blending the liquefied legume material with liquid oil, such as vegetable oil, sunflower oil, peanut oil, olive oil, safflower oil, soybean oil, rapeseed oil, corn or maize oil, and/or cottonseed oil. Other ingredients associated with traditional mayonnaise can be added to modify the taste and/or texture of the product. For example, the product may include salt, sugar, mustard, spices, taste enhancers and the like. As another example, an acid may be blended into the product, such as acetic acid, citric acid, and/or lactic acid. The acid may come from natural sources of such acid, such as lemon juice, vinegar, fermented whey and/or yogurt. The pH of the product may in the range from 3.0 to 5.0, depending on the amount of acid added to the product. While egg may be added to the mayonnaise product for flavor, in some applications, the mayonnaise is an eggless mayonnaise. Because the liquefied legume material can self-emulsify, the egg/egg yolk used for emulsification properties in traditional mayonnaise can be omitted from the product. This allows the mayonnaise to be used by individuals having dietary restrictions that prevent or limit consumption of egg-containing products.

The liquefied legume material can be used to produce eggless versions of other emulsion products traditionally formed using eggs as an emulsification agent. Examples of such products include dips, dressings, and sauces, such as custard, hollandaise sauces, oil-based salad dressings, and the like. A variety of flavoring agents, stabilizers, flavor enhancers, preservatives, and coloring agents may be added to the eggless emulsion products formed using the liquefied legume material. The specific additives used will vary depending on the characteristics of the particular product being produced. Example additives that may be used included, but are not limited to, carrot granules, parsley, onion, sugar, salt, sodium citrate, garlic, black pepper, red bell pepper, carrots, minced green onion, spices and other natural flavors.

The following example may provide additional details about a legume-based processing techniques and products formed in accordance with this disclosure.

### Example 1

A liquefied legume “milk” was manufactured according to the techniques described in the present disclosure and subsequently fermented to produce a yogurt analogue. The characteristics of the example processing technique and resulting yogurt analogue are reported in the following table.

| Processing | Chickpea “yogurt” | 5 lb Batch | |
|---|---|---|---|
| Step | process | Grams | lbs |
| Soak | amount of dried chickpeas | 2268 | 5 |
| | Weight of soaking water | 5000 | 11 |
| | gallons of water | | 1.32 |
| | soak 12 hours at 40 F., | | |
| | refrigerated temp | | |
| | Drain soaking water and | | |
| | discard | | |
| | wash beans once with | | |
| | water | | |
| | soaked weight | 4575 | 10 |
| Enzyme | Total water to be added | 11437.5 | 25 |
| Conversion | to soaked chickpeas | | |
| | (2.5× soaked chickpea | | |
| | weight) | | |
| | gallons of water | | 3.03 |
| | add 30% of water to | | |
| | chickpeas | | |
| | add 70% of water to | | |
| | kettle to pre-heat | | |
| | Total weight | 16012.5 | 35 |
| | Grind Chickpeas into a | | |
| | slurry, check pH (pH | | |
| | 6.55) | | |
| | Add CaCl2 to kettle water | 2.217 | |
| | achieve final 50 ppm Ca | | |
| | Adjust pH to 7 with 1N | 42.9625 | |
| | NaOH, also add to kettle | | |
| | water | | |
| | Add ground chickpeas to | | |
| | kettle | | |
| | Add 2 drops of alpha- | 0.4 | 0.00088 |
| | amylase enzyme per lb | | |
| | dry beans (4 drops total), | | |
| | or 0.0176% | | |
| | Drops of enzyme | 10 | 10 |
| | Heat slurry to 180 F. with | | |
| | stirring, hold 30 minutes | | |
| | (do not heat to boiling) | | |
| | pH held around 7.0-7.2 | | |
| | but never under 6.5 while | | |
| | heating | | |
| Filtration | Filter to remove solids, | 7570 | 16.7 |
| to produce | retain filtrate (lbs) | | |
| “milk” | Gallons of filtrate | | 2 |
| | Cool filtrate between | | |
| | 110 F. and 120 F. | | |
| Culturing and | Add yogurt culture | 0.00167 | 0.00167 |
| Fermentation | (0.01%) (lbs) | | |
| | Yogurt culture (0.01%) | 0.757 | 0.757 |
| | in grams | | |
| | tsp Yogurt culture, 1 tsp = | 0.210278 | 0.210277778 |
| | 3.6 g | | |
| | Ferment at 110 F. for 7 | | |
| | hours or until coagulation | | |
| | occurs and pH < 4.4 | | |
| Filtration and | Filter to remove excess | | |
| Concentration | water and form typical | | |
| | yogurt consistency | | |
| | Yield of pre-filtered | | |
| | yogurt | | |
| | Yield of whey | | |
| | Final Yield (g) | 2290 | |
| | Final Yield | | 5 |
| | filtered/drained (lb) | | |

### Example 2

In order to determine the influence of pH on the formation of a stable emulsion using a chickpea “milk,” five separate samples of dried chickpeas (200 g each) were soaked in 1200 g tap water for 12 hours at 40 F (4.4 C). The soaked chickpeas were then drained and the soak water retained. The drained chickpea samples were each ground in a food processor for 15 seconds, then 200 g of soak water was slowly added during grinding (1 minute) to produce a smooth paste. The chickpea paste and remaining soak water were combined and placed in a 2000 mL beaker. 11.1 g of 1N NaOH solution and 0.19 g of CaCl2 was then added to the beaker and stirred to incorporate. The beaker was placed in a 1200 W microwave and heated in 1 minute increments, with intermittent stirring, until a temperature of 150 F (65.6 C) was attained. One drop (0.049 g) of BAN 480L (alpha-amylase enzyme) was added and stirred to incorporate. The beaker was then heated in the microwave in 1 minute increments, with intermittent stirring, until a temperature of 180 F (82.2 C) was reached. The beaker was held at this temperature for 30 minutes to promote starch conversion, re-heating the beaker every 10 minutes to help maintain 180 F.

After 30 minutes, each of the five samples was treated in a different manner in order to adjust pH prior to milk filtration (e.g., extraction). In sample 1, no additional NaOH was added. In sample 2, 2 g of additional 1N NaOH was added; in sample 3, 3 g of additional 1N NaOH was added; in sample 4, 3.5 g of additional 1N NaOH was added; and in sample 5, 4 g of additional 1N NaOH was added. The solutions were then held for 20 minutes at 180 F (82.2 C), then filtered through a 100 micron screen to produce an extract or “milk.”

Each sample of chickpea “milk” produced according to the technique outlined above was evaluated for solids, pH, emulsion formation, and emulsion measures including Brookfield viscosity and Bostwick flow distance score. Emulsions were formed by placing 50 g of each milk sample in a beaker and slowly adding 134 g of sunflower oil into the milk while mixing with hand held electric immersion blender over 10 minutes. The results are shown in the table below.

| | | Total | | | | Brookfield | |
|---|---|---|---|---|---|---|---|
| | Additional | 1N | | Milk | Emulsion | spindle 6 | Bostwick |
| | 1N NaOH | NaOH | Milk | Solids | Self- | (25 sec) | Consistometer |
| Experiment | (g) | (g) | pH | % | supporting | cP | (1 min) |
| 1 | 0 | 11.1 | 7.07 | 11.00 | No | 912.5 | 9.6 |
| 2 | 2 | 13.1 | 7.21 | 11.06 | No | 1575 | 7.6 |
| 3 | 3 | 14.1 | 7.33 | 10.35 | No | 2450 | 2.7 |
| 4 | 3.5 | 14.6 | 7.44 | 10.67 | Yes | 5100 | 0 |
| 5 | 4 | 15.1 | 7.56 | 10.35 | Yes | 4781 | 0 |

The results above indicate that once starch conversion was complete at pH 7, filtering the resulting chickpea slurry without first adjusting the pH caused components that help form a stable emulsion to be removed from the resulting chickpea milk. An increase in pH above 7.33 (particularly 7.44 and higher in the example data) was needed to produce an emulsion of sufficient viscosity, lack of flow, and self-supporting qualities to yield an emulsion suitable for mayonnaise (or other emulsified products).

### Example 3

In order to determine if the emulsion characteristics of the chickpea milk of Example 2 could be replicated by adjusting pH after filtration, 50 g of chickpea milk formed as described in Example 2 (pH 7.07) was adjusted to pH 7.5 with 1N NaOH dropwise using a pH meter. The adjusted pH milk was then used to make an emulsion, slowly adding 134 g of sunflower oil into the milk while mixing with hand held electric immersion blender over 10 minutes. The resulting emulsion was not self-supporting and did not show any improvement over the unadjusted pH 7.07 milk from Example 2. The results indicated that pH adjustment should be conducted prior to filtration of the chickpea slurry in order to produce a chickpea milk emulsion of sufficient viscosity, lack of flow, and self-supporting qualities to produce a mayonnaise (or other emulsified products).

### Example 4

In order to determine if a specific protein fraction was responsible for the improved emulsions observed at using chickpea milk filtered at elevated pH as described in Examples 2 and 3, a further experiment was conducted. 200 g of dried chickpeas were soaked for 12 hours in 1200 g tap water. The chickpeas were drained, ground in a food processor for 15 seconds, then 200 mL of water was added back while grinding to form a paste. 1000 mL of additional water was added along with 10 g 1N NaOH and 0.19 g CaCl2. The resulting chickpea slurry was placed in a 2000 mL beaker, heated 1 minute at a time until 150 F (65.6 C) was reached, and then 1 drop BAN480L was added. The solution was then heated 1 minute at a time until 180 F (82.2 C) was attained. The beaker was held at 180 F (82.2 C) for 30 minutes, returning the beaker to the microwave every 10 minutes in order to maintain 180 F (82.2 C). After 30 minutes the ground chickpea solution was divided into six 200 g portions and placed into Nalgene screwtop bottles. Different quantities of additional 1N NaOH (0, 0.2, 0.4, 0.6, 0.8, and 1.0 g) were added to each bottle. The bottles were then incubated in a water bath maintained at 180 F (82.2 C) for 20 minutes. Samples were then filtered through a 100 micron screen to form milks each having a different pH. The samples are summarized in the following table.

| Sample | Additional 1N NaOH (g) | pH of Chickpea Milk |
|---|---|---|
| Control | 0 | 7.12 |
| 1 | 0.2 | 7.22 |
| 2 | 0.4 | 7.37 |
| 3 | 0.6 | 7.54 |
| 4 | 0.8 | 7.69 |
| 5 | 1.0 | 7.92 |

A SDS PAGE (sodium dodecyl sulfate polyacrylamide gel electrophoresis) was conducted on each of the milk samples. Samples of each milk were incubated with Laemmli reducing buffer, heated, and loaded onto a Criterion gradient gel (10.5-14%) Tris HCl 1 mm, run at 200V constant voltage. In addition, a sample of whole ground chickpea, a sample of liquid drained from a can of chickpeas (also known as “aquafaba”, designated “AQFB” on gel), and molecular weight standards were also run on the same gel. All samples were loaded to a target of 15 ug protein.

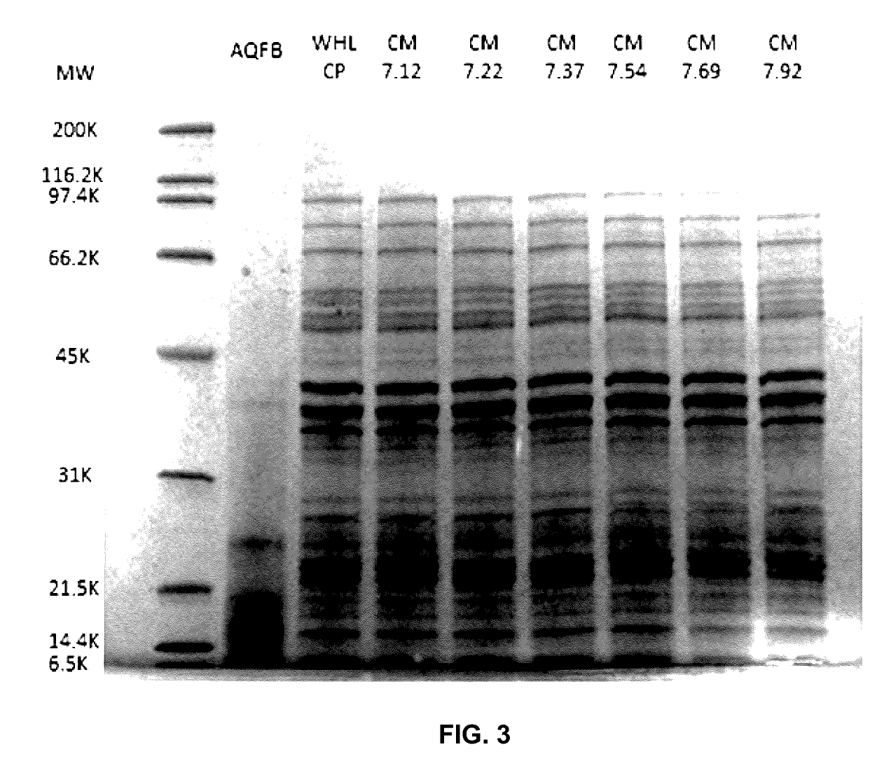

After electrophoresis was completed, the gel was stained with BioSafe coomassie stain. FIG. 3 is an image of the electrophoresis produced from the experiment. The results did not indicate any noticeable change in protein profile over the range of pH adjustment conducted prior to chickpea milk extraction, and did not explain the stronger emulsions observed at higher extraction pH. Chickpea milk samples reflected the protein profile of whole chickpea. In contrast, the sample of liquid from a can of chickpeas contained primarily diffuse low molecular weight bands.

### Example 5

The experiment in this Example was conducted to explore a variety of legumes for production of milk extracts after amylase treatment and determine functional qualities of these extracts. 200 g each of green lentils, fava beans, yellow peas, and pinto beans were soaked in 1200 g tap water at 40 F (4.4 C) for 12 hours. Samples were drained, ground in a food processor, then soak water was added back slowly with grinding to form a paste. The remaining soak water was combined and pH determined. 1N NaOH was added to achieve a pH close to 7, and 0.19 g CaCl2 was added. Samples were heated in a microwave to achieve 150 F (65.6 C), 2 drops of BAN 480L were added, and the samples were then heated to 180 F (82.2 C) and held for 30 minutes.

Half of each sample was filtered through a 100 micron screen to produce a “milk 1.” To the remaining half, additional 1N NaOH was added to achieve pH 7.5 or slightly above. The samples were maintained at 180 F (82.2 C) for an additional 20 minutes prior to being filtered through a 100 micron screen to produce a higher pH “milk 2.” 70% oil emulsions were made from all milk samples, and the lower pH milk samples were further inoculated with yogurt cultures to determine suitability for yogurt formation. The results are presented in the table below.

| | | | Bostwick | Yogurt | | | Bostwick |
|---|---|---|---|---|---|---|---|
| | pH of | % Solids | of milk 1 | curd | pH | % solids | of milk 2 |
| Legume | milk 1 | milk 1 | emulsion | formation | milk 2 | milk 2 | emulsion |
| Green Lentil | 7.08 | 10.8 | 0 | yes | 7.73 | 11.05 | 0 |
| Yellow pea | 7.15 | 10.54 | 0 | yes | 7.60 | 11.02 | 0 |
| Fava bean | 7.18 | 9.04 | 0 | yes | 7.61 | — | 0 |
| Pinto bean | 6.86 | 8.3 | 0 | no | 7.53 | 8.54 | 0 |

The results indicated that unlike chickpea milk, strong emulsions were formed from all milks at both pH levels. In addition, all legume milks formed yogurt products after fermentation with yogurt cultures over 6 hours with the exception of pinto milk, which did not form a solid curd but remained a semi liquid.

### Example 6

An experiment was conducted to compare the characteristics of a legume milk produced in accordance with the disclosure with “aquafaba.” Aquafaba is the drained liquid from retorted cans of chickpeas, which has recently begun being used by vegan home cooks and chefs.

In order to determine the quality of emulsions made by aquafaba compared with legume milks made according to the present disclosure, the following experiment was conducted: a can of commercial chickpeas (Progresso) was poured through a kitchen strainer to separate the aquafaba from the chickpeas. The aquafaba was further passed through a 425 micron screen. 50 mL of strained chickpea aquafaba was placed in a beaker, and 134 g of sunflower oil was added slowly over 10 minutes during blending with a hand held immersion blender. The emulsion that formed was tested using a Bostwick Consistometer, and a value of 21.4 was attained after 1 minute, demonstrating a high degree of fluidity and lack of firmness.

Emulsions made under the same conditions but using legume extracts (milks) as described above (including fava, lentil, yellow pea, pinto, and chickpea milk) were tested and shown to exhibit superior emulsion strength compared with aquafaba. In addition, as shown in Example 4 utilizing SDS PAGE, the protein profile of aquafaba was shown to be very different from both whole chickpea or the chickpea milks made using the present disclosure, containing fewer protein bands and primarily small molecular weight protein bands. The results of the Example are provided in the following table.

| | Bostwick Consistometer |
|---|---|
| | (1 min) of 72% oil emulsion |
| Legume Sample | made with legume sample |
| Chickpea Milk (extracted at pH 7.07) | 9.6 |
| Chickpea Milk (extracted at pH 7.44) | 0 |
| Green Lentil Milk (extracted at 7.08 or 7.73) | 0 |
| Yellow Pea Milk (extracted at 7.15 or 7.60) | 0 |
| Fava Bean Milk (extracted at 7.18 or 7.61) | 0 |
| Pinto Bean Milk (extracted at 6.86 or 7.53) | 0 |
| Aquafaba (drained from can of chickpeas) | 21.4 |

Various examples have been described. These and other examples are within the scope of the following claims.

1. A method of producing a cultured food product comprising:
hydrating a non-soy legume having greater than 20 weight percent starch on a dry weight basis with water to produce a hydrated legume material by at least one of rinsing the legume with water and soaking the legume in water;
separating the hydrated legume material from excess water used to at least one of rinse the legume and soak the legume;
combining the hydrated legume material with amylase to provide a legume slurry;
heating the legume slurry to a temperature greater than 150 degrees Fahrenheit but below boiling for a period of time sufficient to reduce a starch content of the legume slurry below 5 weight percent on a dry weight basis and thereby provide a legume slurry of reduced starch content;
filtering the legume slurry of reduced starch content;
adjusting a temperature of the legume slurry of reduced starch content to a range effective to activate a bacterial culture when added to the legume slurry of reduced starch content;
adding the bacterial culture to the legume slurry of reduced starch content; and
holding the legume slurry of reduced starch content with bacterial culture at the adjusted temperature for a period sufficient to acidify the legume slurry of reduced starch content to a pH of 4.7 or below, thereby producing a cultured non-dairy product.

2. The method of claim 1, wherein the non-soy legume comprises at least one of chickpeas, adzuki beans, fava beans, and red lentils.

3. The method of claim 1, wherein heating the legume slurry to a temperature greater than 150 degrees Fahrenheit but below boiling comprises heating the legume slurry to a temperature ranging from 160 degrees Fahrenheit to 185 degrees Fahrenheit, and adjusting the temperature of the legume slurry of reduced starch content comprises adjusting the temperature of the legume slurry to a temperature ranging from 100 degrees Fahrenheit to 120 degrees Fahrenheit.

4. The method of claim 1, wherein heating the legume slurry for the period of time sufficient to reduce the starch content comprises heating the legume slurry for the period of time sufficient to reduce the starch content comprises to a range from 0.5 to 3 weight percent starch on the dry weight basis.

5. The method of claim 1, further comprising adding a non-dairy milk to the legume slurry of reduced starch content, wherein holding the legume slurry of reduced starch content with bacterial culture comprises holding the legume slurry of reduced starch content and non-dairy milk with bacterial culture.

6. The method of claim 5, wherein the non-dairy milk comprises at least one of almond milk and coconut milk.

7. The method of claim 1, wherein the bacterial culture comprises Lactobacillus bulgaricus and Streptococcus thermophilus and the cultured non-dairy product is a yogurt analogue.

8. The method of claim 7, wherein holding the legume slurry of reduced starch content with bacterial culture at the adjusted temperature comprises holding for the period of time ranges from 4 hours to 8 hours.

9. The method of claim 7, further comprising adding an acidifying ingredient to the yogurt analogue.

10. The method of claim 9, wherein the acidifying ingredient comprises citric acid.

11. The method of claim 1, further comprising, prior to filtering the legume slurry of reduced starch content, increasing the pH of the legume slurry of reduced starch content.

12. The method of claim 11, wherein the non-soy legume comprises chickpeas and increasing the pH comprises increasing the pH of the legume slurry of reduced starch content to a pH greater than 7.3

13. A cultured non-dairy product comprising:
a cultured non-soy legume composition having a starch content ranging from 0.5 weight percent to 3 weight percent starch, a pH less than 4.7, and a viscosity ranging from 15,000 centipoise to 30,000 centipoise when measured at a temperature of 5 degrees Celsius,
wherein the cultured non-soy legume composition is substantially devoid of particles having a size greater than 0.5 millimeters, and
the cultured non-soy legume composition is substantially devoid of dairy products.

14. The product of claim 13, wherein the cultured non-soy legume composition comprises at least one of a cultured chickpea composition, a cultured adzuki bean composition, a cultured fava bean composition, and a cultured red lentil composition.

15. The product of claim 13, wherein the cultured non-soy legume composition further comprises an acidifying ingredient.

16. The product of claim 15, wherein the acidifying ingredient comprises citric acid.

17. The product of claim 13, further comprising at least one of a milk and cream of a fruit or tree nut.

18. The product of claim 13, further comprising at least one of coconut cream and almond cream.

19. The product of claim 13, wherein the cultured non-soy legume composition further comprises a probiotic.

20. A method for producing a legume-based dairy substitute comprising:
hydrating a legume having greater than 20 weight percent starch on a dry weight basis with water to produce a hydrated legume material;
milling the hydrated legume material to reduce a size of the hydrated legume material;
combining the hydrated legume material of reduced size with water and amylase to produce a legume slurry;
heating the legume slurry to a temperature greater than 150 degrees Fahrenheit but below boiling for a period of time sufficient to reduce a starch content of the legume slurry below 5 weight percent on a dry weight basis and thereby provide a legume slurry of reduced starch content; and
filtering the legume slurry.

21. The method of claim 20, wherein the legume comprises at least one of a non-soy bean and a pea.

22. The method of claim 20, wherein the legume consists essentially of chickpeas.

23. The method of claim 20, wherein the hydrating the legume comprises soaking the legume in water at a temperature less than 50 degrees Fahrenheit for a period of at least one hour, wherein a volume ratio of the legume to water ranges from 1:0.5 to 1:5.

24. The method of claim 23, wherein milling the hydrated legume material comprises:
draining the water from the hydrated legume material in which the hydrated legume material is soaking; and
grinding the hydrated legume material to an average particle size less than 300 microns.

25. The method of claim 24, wherein grinding the hydrated legume material comprises grinding the hydrated legume material at least one of under vacuum and in a non-oxygen atmosphere so as to inhibit oxidation of the hydrated legume material.

26. The method of claim 20, wherein the amylase comprises alpha-amylase.

27. The method of claim 20, further comprising adjusting a pH of the legume slurry to a range effective to activate the enzyme to enzymatically digest the starch content of the legume slurry while preventing substantial precipitation of proteins in the legume slurry.

28. The method of claim 27, wherein adjusting the pH comprises adjusting the pH to the range from 6.5 to 7.2.

29. The method of claim 27, wherein adjusting the pH comprises adding calcium hydroxide to the legume slurry or a constituent component thereof, thereby increasing a calcium concentration of the legume slurry.

30. The method of claim 29, further comprising, prior to filtering the legume slurry, increasing the pH of the legume slurry of reduced starch content to a pH greater than 7.3.

31. The method of claim 20, wherein the period of time to reduce the starch content of the legume slurry below 5 weight percent ranges from 30 minutes to 4 hours.

32. The method of claim 20, wherein heating the legume slurry comprises heating the legume slurry to a temperature ranging from 160 degrees Fahrenheit to 185 degrees Fahrenheit.

33. The method of claim 20, wherein heating the legume slurry for the period of time sufficient to reduce the starch content comprises heating the legume slurry for the period of time sufficient to reduce the starch content comprises to a range from 0.5 to 3 weight percent starch on the dry weight basis.

34. The method of claim 20, wherein filtering the legume slurry of reduced starch content comprises filtering out particles larger than 0.5 mm.

35. The method of claim 20, further comprising:
adjusting a temperature of the legume slurry of reduced starch content to a range from 100 degrees Fahrenheit to 120 degrees Fahrenheit;
adding a bacterial culture to the legume slurry of reduced starch content; and
holding the legume slurry of reduced starch content with bacterial culture at the adjusted temperature for a period sufficient to acidify the legume slurry of reduced starch content to a pH of 4.7 or below, thereby producing a cultured dairy substitute product.

36. The method of claim 35, wherein the period sufficient to acidify ranges from 4 hours to 8 hours.

37. The method of claim 35, wherein the bacterial culture comprises Lactobacillus bulgaricus and Streptococcus thermophilus and the cultured dairy substitute product is a yogurt analogue.

38. The method of claim 35, further comprising adding an acidifying ingredient to the yogurt analogue.

39. The method of claim 38, wherein the acidifying ingredient comprises citric acid.

40. An eggless emulsion product comprising:
an aqueous non-soy legume composition forming an emulsion with oil and being devoid of egg.

41. The product of claim 40, wherein the oil ranges from 50 weight percent to 85 weight percent of the product.

42. The product of claim 40, wherein the aqueous non-soy legume composition comprises a non-soy milk formed of at least one of a chickpeas, adzuki beans, fava beans, and red lentils.

43. The product of claim 40, further comprises an acidifying ingredient.

44. The product of claim 43, wherein the acidifying ingredient is vinegar.

45. The product of claim 40, wherein the product is an eggless mayonnaise.
